(19) United States
(12) Patent Application Publication
(10) Pub. No.: US 2007/0006863 A1
(43) Pub. Date: Jan. 11, 2007

(54) Portable, collapsible, folding charcoal grill

(76) Inventor: Steven Barbarich, San Francisco, CA (US)

Correspondence Address: HOWARD M COHN;PATENT ATTORNEY LLC, 21625 CHAGRIN BLVD #220, CLEVELAND, OH, 44122, US

(21) Appl. No.: 11/360,225

(22) Filed: Feb. 23, 2006

Related U.S. Application Data
(60) Provisional application No. 60/595,473, filed on Jul. 8, 2005.

(51) Int. Cl. A47J 37/07; F24C 1/16

(52) U.S. Cl. 126/9 R; 126/25 R

(57) ABSTRACT

The present invention is a lightweight, collapsible, easy to use, compact, flat and portable charcoal grill for use in barbeque type cooking. Multiple hinges allow the grill to be folded into a flat mode for storage and transport. The grill has two carrying handles. It is made of steel that might or might not be painted.

### CROSS-REFERENCE TO RELATED APPLICATIONS

This application claims the benefit of U.S. Provisional Patent Application No. 60/595,473 filed on Jul. 8, 2005 which is incorporated herein by reference.

### FIELD OF THE INVENTION

The present invention relates to charcoal grills, and specifically to a compact, folding, portable charcoal grill.

### BACKGROUND

Commercially available charcoal grills are designed mostly for outdoor use, typically in back yards or on patios or decks. They are typically made of heavy sheet steel or cast aluminum so as to withstand the rigors of years of outdoor storage and use. They are large, heavy, and bulky. Because of their weight their designs typically include wheels and one or more steering handles to make them relatively easy to move over short distances on smooth, level surfaces. When used, such large charcoal grills commonly hold between five and twenty pounds of charcoal, which is usually poured from a bag into the grill. The charcoal must then be coated with a combustible fluid in order to facilitate ignition and uniform burning of the coals.

Commercially available charcoal grills that are designed for portability, tend still to be bulky. They have to be at least partially disassembled prior to being transported in a car or van.

Because such typical commercial charcoal grills weigh between tens of pounds and a hundred pounds or more, and because they are large and bulky, they cannot easily, and usually only with difficulty, be transported to other sites of use such as beaches or picnic grounds, nor can they easily or conveniently be taken on camping trips.

An additional difficulty in trying to use a standard large type of charcoal grill of the sort described above in other than a home situation is the weight and bulk of the bags of charcoal.

Below is a list of patents which generally relate to the present invention but still fail to overcome the problems of the prior art grills.

U.S. Pat. No. 4,829,975, to Hait, entitled, ‘COOKING UNIT WITH IMPROVED FIRE GRATE,’ describes a collapsible “fire grate is formed with a slot configured to receive a narrow dimensioned section of a briquette.” While this cooking unit taught by Hait, is small and light in weight, it disassembles into multiple components that can become separated from one another.

U.S. Pat. No. 5,495,845, to Hait, entitled, ‘COMPACT OUTDOOR COOKING UNIT,’ describes a collapsible “compact outdoor cooking unit having a cooking mode and a transport and storage mode. The outdoor cooking unit has a foldable stove. In the cooking mode, the stove is in the extended state.” As with Hait's '975 invention (above), this '845 unit has multiple components that can be physically separated from one another in ways that complicate the collapsible feature. That is to say, this '845 invention, as with the '975 invention of Hait, is not unitary in its collapsible design. Also, in its collapsed state, it is several inches thick, and it appears to be both bulky and heavy.

U.S. Pat. No. 4,714,013, to Telfer, entitled ‘COLLAPSIBLE COOKING UNIT,’ also describes a “cooking unit formed with four side panels hinged along adjacent sides. A pair of opposite side panels are hinged between the sides thereof in parallel relation to the hinges joining the adjacent sides thereof. The cooking unit in an extended state is hollow, and in cross-section has a rectangular or square configuration.” This invention of includes a single detachable handle that easily can be misplaced and even lost. Because it is not unitary in its collapsible design, i.e., having all its parts connected to one another, the component parts can be misplaced and lost. Furthermore, it lacks an integral cooking surface in close proximity to the charcoal fuel.

U.S. Pat. No. 5,103,799, to Atanasio, entitled, ‘COLLAPSIBLE BARBEQUE GRILL,’ is a “collapsible charcoal grill has two [wire] frames pivoted together at one end. One frame is retained in a vertical position by struts and the other frame has folding support means.” It lacks the ability to fold or collapse entirely flat, and, because it can be disassembled, i.e., is not unitary in its collapsible design, the component parts can be misplaced and lost.

Other less relevant, and usually larger units that are called portable because then have wheels or are designed to be carried in cars include the following:

U.S. Pat. No. 6,814,383, to Reed, III, et al., entitled ‘TAILGATING SYSTEM AND METHOD FOR TAILGATING’;

U.S. Pat. No. 6,827,076 to Crawford, et al., entitled, ‘QUICK START BARBECUE’;

U.S. Pat. No. 6,736,128, to Nordeen, entitled, ‘MULTIPLE MODE CHARCOAL COOKER’;

U.S. Pat. No. 6,725,856, to Barbour, et al., entitled, ‘OUTDOOR GAS COOK STOVE WITH KNOCKDOWN LEGS,’ is gas-fired;

U.S. Pat. No. 6,189,528, to Oliver, is entitled, ‘OUTDOOR COOKING SYSTEM’;

U.S. Pat. No. 6,131,560, to Healy, entitled, ‘PORTABLE GRILL WITH TELESCOPIC LEGS’;

U.S. Pat. No. 6,125,835, to Montano, entitled ‘CAMPING RANGE’;

U.S. Pat. No. 6,050,257, to Bond, is called, ‘DISASSEMBLEABLE GRILL;’

U.S. Pat. No. 5,947,013, to Stewart, Jr., is entitled, ‘OUTDOOR GRILL FOR CHARCOAL GRILLING’;

U.S. Pat. No. 5,605,142, to Parker, entitled, ‘PORTABLE BARBEQUE’;

U.S. Pat. No. 4,762,114, to Blankemeyer, entitled, ‘PORTABLE COOKING APPARATUS WITH A REMOVABLE WORK TABLE; and

U.S. Pat. No. D381,551, to Sternberg, entitled, ‘PORTABLE GRILL.’

### SUMMARY OF THE INVENTION

The present invention is a light weight, collapsible, portable charcoal grill comprising four flat regular quadrangular members that are joined by hinges to form a rectangular basket. The four members comprise a front member having a top edge and a bottom edge that are parallel to one another and a mid region therebetween, a rear member having a top edge and a bottom edge that are parallel to one another and a mid region therebetween, and two side members each having a top edge and a bottom edge that are parallel to one another, a horizontal charcoal holding surface; a horizontal cooking surface disposed above and displaced from the horizontal charcoal holding surface and two carrying handles. Each of the four flat regular quadrangular members is a bilaterally symmetrical trapezoid, and each of the two side members has an inward folding hinge disposed perpendicular to the top edge and the bottom edge more or less defining an axis of symmetry of each bilaterally symmetrical trapezoid side member. Each of the two side members has mirror symmetry with respect to the other and one side of each bilaterally symmetrical trapezoid of each of the two side members has a stop disposed about midway between the top edge and the bottom edge. The four flat regular quadrangular members, the horizontal charcoal holding surface, and the horizontal cooking surface displaced from and disposed above the horizontal charcoal holding surface are made of metal, such as steel having a thickness of about 0.015 inch to about 0.035 inch. The steel is painted. The horizontal charcoal holding surface is hingedly connected to the front member near the bottom edge of said front member. The horizontal cooking surface disposed above and displaced from the horizontal charcoal holding surface comprises a front cooking surface portion having holes there through and a rear cooking surface portion having holes there through. The front cooking surface portion is hingedly connected to the front member in the mid region between to top edge and the bottom edge of said front member, and the rear cooking surface portion is hingedly connected to the rear member in the mid region between to top edge and the bottom edge of said rear member. Each of the two carrying handles is made of metal wire and hingedly connected respectively near the top edge of the front member near the top edge of the rear member. The metal wire of the handles is steel and has a diameter of about 0.1 inch to about 0.2 inch. The hinges that join the four flat regular quadrangular members to form a rectangular basket comprise bent interlocking tabs that are joined by metal pins. The horizontal charcoal holding surface is rectangular and has corners that are beveled. The rear flat regular quadrangular member having a top edge and a bottom edge that are parallel has a plurality of air holes disposed near the bottom edge.

### BRIEF DESCRIPTION OF THE DRAWINGS

FIG. 1 is an orthogonal side view of the present invention;

FIG. 2 is an orthogonal view of the top portion of the present invention in its folded mode;

FIG. 3 is an orthogonal top view of the present invention, shown partially unfolded;

FIG. 4A is an orthogonal top view of the present invention, shown with bottom panel partially unfolded;

FIG. 4B is a sectional view in the direction indicated in FIG. 4A;

FIG. 5 is an orthogonal top view of the present invention, shown almost completely unfolded for use; and

FIG. 6 is an orthogonal top view of the present invention, shown completely unfolded for use.

### DETAILED DESCRIPTION OF THE PREFERRED EMBODIMENT

The present invention addresses the need for a lightweight, easy-to-use, compact, collapsible, portable, disposable, and low-cost barbecue grill. The light weight, collapsible, portable charcoal grill according to the present invention is designed for easy carrying because it is light in weight and it folds or collapses into a flat shape that is easily portable, and also has two carrying handles. It is made of metal, such as steel, having a thickness of about 0.015 inch to about 0.035 inch, and it may be able to be painted. It does not dissemble, but rather simply collapses into a thin and flat, easy-to-store-and-carry single object. That is to say, the present invention is unitary in design, having no provision for disassembly or removal of any of its component parts.

The accompanying FIGURES serve to describe this folding, portable charcoal or barbeque grill invention.

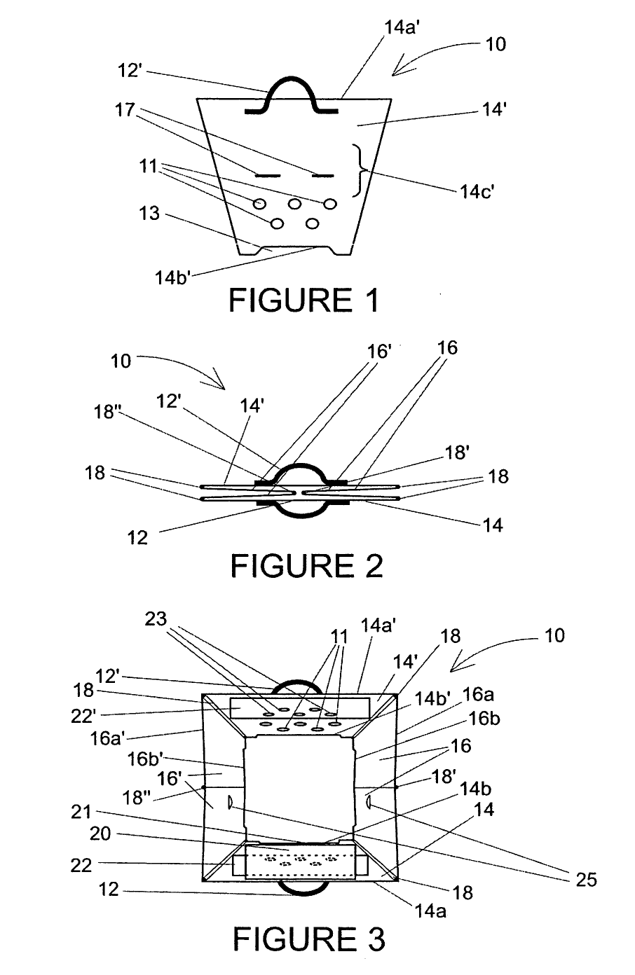

FIG. 1 is an orthogonal side view of the present folding grill invention 10, showing one handle 12′ that is hingedly attached to a flat member 14′ having a top edge 14a′ and a bottom edge 14b′ that are parallel to one another and a mid region 14c′ therebetween. Note the cutout 13 area in bottom edge 14b′ of the panel 14′. Four such cutouts, one on each of the four side members of the present invention, allow cooling air to move beneath the grill invention when it is being used; they minimize heat transfer to the surface upon which the grill invention 10 is situated. Air holes 11 allow air to reach the charcoal in the bottom of the invention 10 when it is being used. Sheet metal hinges 17 support one of two horizontal cooking surface surfaces 22,22′ that are shown in FIGS. 3,3A,4 and 5.

FIG. 2 is an orthogonal top view of the present invention 10 in its folded or collapsed mode. There is a first handle 12 hingedly attached to the flat front member 14, and a second handle 12′ hingedly attached to a flat rear member 14′. Hinges 18 allow the front and rear side members 14,14′, and the two side members 16,16,′ which have inward folding hinges 18′,18″ to fold inward, thereby making the invention 10 collapsible into a flat mode for compact storage and easy transport. The inward folding hinges 18′,18″ are disposed more or less upon the axis of bilateral symmetry of the regular trapezoidal inward folding side members 16,16′. Hinges denoted by the numeral 18 join the rigid panels 14,14′ to the folding inward folding panels 16,16′, all of which are generally a flat quadrangular members when the invention is uncollapsed, and, specifically, they are regular, bilaterally symmetrical trapezoids having respective top edges 14a,14a′,16a,16a′ that are parallel to respective bottom edges 14b,14b′,16b,16b′.

FIG. 3 is an orthogonal top view of the present invention 10 in a partially deployed mode with its first and second flat panels 14,14′ and first and second folding side panels 16,16′ unfolded about hinge points 18. FIG. 3, taken in conjunction with FIGS. 1 and 2, reveal the rectangular basket shape of the invention 10 when it is deployed for use and the four flat regular quadrangular members 14,14′,16, 16′ that form the rectangular basket shape. Bottom panel 20 is a horizontal charcoal holding surface when it is folded to its downward position; it is shown in its up-folded or stowed position in FIG. 3. The charcoal holding panel 20 is attached to the first flat panel 14 by means of hinge 21 that is disposed near to the bottom edge 14b of the front member 14. A grill surface that is made up of two parts 22,22′, which, in FIG. 3, are shown in their upward folded positions. The two parts 22,22′ of the cooking surface are horizontal when the stove 10 is deployed for use. The second grill surface portion 22′ is hingedly connected to the rear member 14′ in the midpoint region 14c′ (FIG. 1), while the first grill surface 22 is hingedly connected to a corresponding midpoint in the front member 14. The first grill surface 22, when folded downward during use of the invention 10, rests upon the stops 25, which are cut indentations in the respective sides of the inward folding members 16,16′ which are essentially mirror image reflections of one another in their basis designs. In FIG. 3, the two portions 22,22′ of the horizontal cooking surface are shown in their up-folded or stowed positions. Holes 23 permit heated gases from charcoal fuel, which burns upon the bottom panel 20 (when folded downward), to convect upward and make contact with food being cooked on the panels 22,22′ of grill 10. FIG. 3 shows the first grill portion 22 to be partially hidden behind the up folded bottom panel 20.

The two carrying handles 12,12′ are made of metal wire, preferably steel, having a diameter of about 0.1 inch to about 0.2 inch and they are respectively hingedly connected near the top edge 14a of the front member 14 and the top edge 14a′ of the rear member 14′.

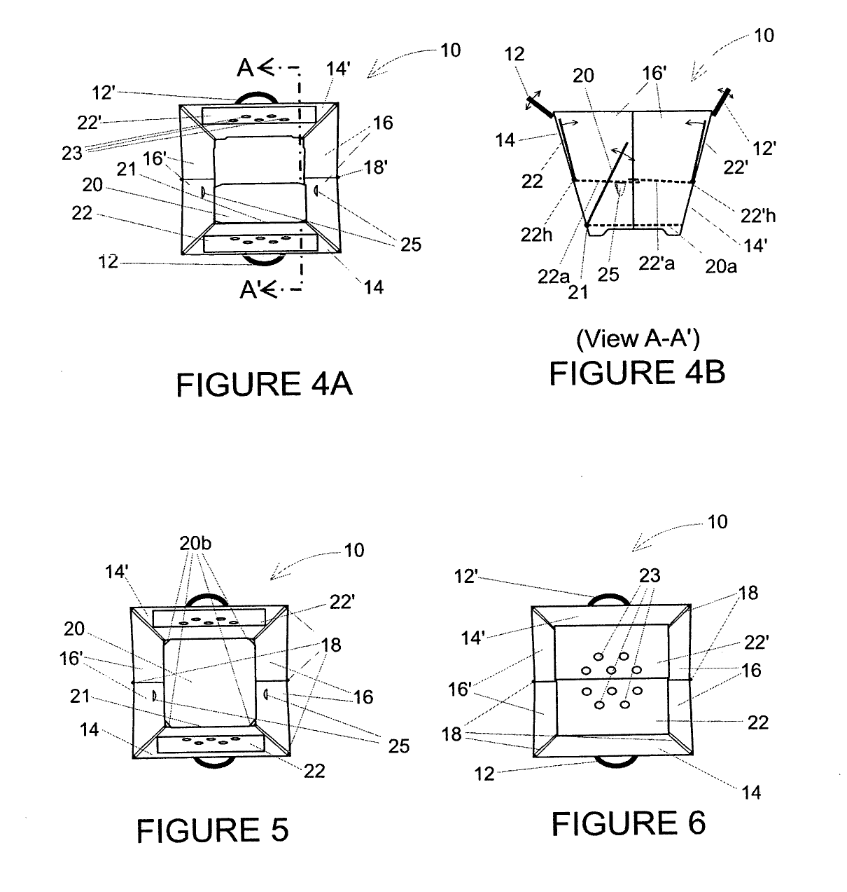

FIG. 4A is an orthogonal top view of the present invention 10 in a partially unfolded or uncollapsed mode with its front and rear flat regular quadrangular members 14,14′ and its first and second inward folding regular quadrangular members 16,16′ unfolded and the rectangular bottom panel 20 oriented partially downward with respect to hinge 21. FIG. 4B is a sectional view A-A′, as indicated in FIG. 4A. FIGS. 4A and 4B show both the first and the second grill surfaces 22,22′ to be folded against the first and second side members 14,14′ about hinge points 22h,22′h respectively. Dotted line 20a shows the downward-most position of the bottom panel 20. Dotted lines 22a,22′a show the downward-most positions of the grill surface portions 22,22′ respectively. Note in FIG. 4B that the grill surface portion 22, in its downward-most position 22a, rests upon the cut-metal stop 25, two of which are shown in the top of FIG. 4A. When the grill surfaces 22,22′ are downward deployed, as shown with dotted lines 22a,22a′ in FIG. 4B, that the grill surface 22′ rests upon the grill surface 22.

During use, charcoal is loaded upon the bottom panel 20 (i.e., 20a in the fully downward deployed position in FIG. 4B) prior to the first and second grill portions 22,22′ being folded downward into horizontal positions 22a,22a′.

FIG. 5 is an orthogonal top view of the folding grill invention 10 with the bottom rectangular panel 20 shown fully deployed downward, to form a horizontal charcoal holding surface, ready to receive a charge of charcoal. Said panel 20 has four beveled corners 20b, which serve the dual purpose of allowing the user's fingers to grasp the panel 20 and pull it upward for purposes of stowage of the invention 10, and also to allow air to reach the burning charcoal contained upon the surface 20. The two horizontal cooking surface portions 22,22′ are shown in their undeployed or stowed (upward) positions.

FIG. 6 is an orthogonal top view of the present invention 10 in its fully unfolded mode. The first and second horizontal cooking surface portions 22,22′ are deployed into a horizontal grilling surface.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A light weight, collapsible, portable charcoal grill comprising:
four flat regular quadrangular members are joined by hinges to form a rectangular basket and comprising:
a front member having a top edge and a bottom edge that are parallel to one another and a mid region therebetween;
a rear member having a top edge and a bottom edge that are parallel to one another and a mid region therebetween; and
two side members each having a top edge and a bottom edge that are parallel to one another; and
a horizontal charcoal holding surface;
a horizontal cooking surface disposed above and displaced from the horizontal charcoal holding surface; and
two carrying handles.

2. The light weight, collapsible, portable charcoal grill of claim 1 wherein:
each of the four flat regular quadrangular members is a bilaterally symmetrical trapezoid.

3. The light weight, collapsible, portable charcoal grill of claim 2 wherein:
each of the two side members has an inward folding hinge disposed perpendicular to the top edge and the bottom edge more or less defining an axis of symmetry of each bilaterally symmetrical trapezoid side member.

4. The light weight, collapsible, portable charcoal grill of claim 3 wherein:
each of the two side members has mirror symmetry with respect to the other and one side of each bilaterally symmetrical trapezoid of each of the two side members has a stop disposed about midway between the top edge and the bottom edge.

5. The light weight, collapsible, portable charcoal grill of claim 1 wherein:
the four flat regular quadrangular members, the horizontal charcoal holding surface, and the horizontal cooking surface displaced from and disposed above the horizontal charcoal holding surface are made of metal.

6. The light weight, collapsible, portable charcoal grill of claim 5 wherein the metal is steel.

7. The light weight, collapsible, portable charcoal grill of claim 6 wherein the steel has a thickness of about 0.015 inch to about 0.035 inch.

8. The light weight, collapsible, portable charcoal grill of claim 7 wherein the steel is painted.

9. The light weight, collapsible, portable charcoal grill of claim 1 wherein:
the horizontal charcoal holding surface is hingably connected to the front member near the bottom edge of said front member.

10. The light weight, collapsible, portable charcoal grill of claim 1 wherein:
the horizontal cooking surface disposed above and displaced from the horizontal charcoal holding surface comprises two parts:
a front cooking surface portion having holes there through; and
a rear cooking surface portion having holes there through.

11. The light weight, collapsible, portable charcoal grill of claim 10 wherein:
the front cooking surface portion is hingedly connected to the front member in the mid region between to top edge and the bottom edge of said front member; and
the rear cooking surface portion is hingedly connected to the rear member in the mid region between to top edge and the bottom edge of said rear member.

12. The light weight, collapsible, portable charcoal grill of claim 1 wherein:
each of the two carrying handles is made of metal wire.

13. The light weight, collapsible, portable charcoal grill of claim 12 wherein:
one of the two carrying handles is hingedly connected near the top edge of the front member; and
one of the two carrying handles is hingedly connected near the top edge of the rear member.

14. The light weight, collapsible, portable charcoal grill of claim 12 wherein:
the metal wire is steel.

15. The light weight, collapsible, portable charcoal grill of claim 12 wherein:
the metal wire has a diameter of about 0.1 inch to about 0.2 inch.

16. The light weight, collapsible, portable charcoal grill of claim 15 wherein the metal wire is painted.

17. The light weight, collapsible, portable charcoal grill of claim 1 wherein:
the hinges that join the four flat regular quadrangular members to form a rectangular basket comprise bent interlocking tabs that are joined by metal pins.

18. The light weight, collapsible, portable charcoal grill of claim 1 wherein:
the horizontal charcoal holding surface is rectangular and has corners.

19. The light weight, collapsible, portable charcoal grill of claim 18 wherein:
the corners are beveled.

20. The light weight, collapsible, portable charcoal grill of claim 1 wherein:
the rear member having a top edge and a bottom edge that are parallel has a plurality of air holes disposed near the bottom edge.
